(19) United States
(12) Patent Application Publication
(10) Pub. No.: US 2009/0094740 A1
(43) Pub. Date: Apr. 16, 2009

(54) Automatic water faucet built-in with hot and cold water control valve

(76) Inventor: Sung-Man Ji, Gyeonggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/006,998

(22) Filed: Jan. 8, 2008

(30) Foreign Application Priority Data
Oct. 12, 2007 (KR) 10-2007-0102879

(51) Int. Cl. E03C 1/05; F17D 3/00; F16K 31/02; G05D 23/13

(52) U.S. Cl. 4/623; 251/129.03; 137/624.11

(57) ABSTRACT

Automatic water faucet in accordance with the present invention comprises main body is formed with outlet and hot and cold water inlets; hot and cold water flow control valve is built in the upper part of main body and selects and controls hot and cold water flow rate; control handle for adjustment of hot and cold water flow control valve; object detector device is installed in front of main body and comprises light generator and receiver, operation indicator lamp, circuit board; electronic valve is installed and connected to the bottom of hot and cold water flow control valve automatically opens or closes outlet in accordance with the detector signal of object detector part; battery power supply supplies power to object detector part and electronic valve; and manual emergency lever is installed on the bottom of main body to be able to be rotated to enforce operation of electronic valve manually.

### FIELD OF THE INVENTION

This invention relates to an automatic hot and cold water mixing faucet. In more detail, an automatic water faucet which can be used both automatically and manually, select and control mix ratio of hot and cold water flow, and used when battery is discharged or in emergency cases.

### BACKGROUND OF THE INVENTION

In general, water faucets are furnished and used in rest rooms or bathrooms to supply cold and/or hot water, and can be coarsely classified into automatic and manual faucet.

With manual faucets, though users can select hot and cold water and control flow at desired rate, however, the flow cannot be closed after a certain time resulting in waste of water.

To this end, automatic faucets are being offered and used to reduce water consumption and prevent waste.

The automatic faucet that automatically opens and closes the valve according to the detection by the sensor is installed in the bathrooms of public buildings or houses saving more water than the existing manual faucet. Furthermore, because it needs not to be controlled manually by hand, people can use it sanitarily without a worry about the sanitation, it is more and more widely used.

However, the conventional automatic faucets had some structural problems that the user could not choose between hot and cold water because the faucet didn't have the valve for controlling the amount of cold or hot water and therefore could not properly control the amount of the water. Furthermore, the automatic faucet stopped working if the electronic parts didn't work in case of battery discharge or emergency.

### BRIEF SUMMARY OF THE INVENTION

This invention is aimed at solving the aforementioned faults by providing the automatic faucet that can be used both manually and automatically, has a control valve for the user to properly control the amount of the flushing water and to choose between cold or hot water and can provide cold and hot water uninterruptedly even when the electronic parts stop operating in case of battery discharge or emergency.

To achieve such goals of this invention, the automatic faucet is equipped with the outlet and hot and cold water inlets in the main body with the light generator, light receiver, operation indicator lamp (LED) and object detector with a circuit board connected to the front of the main body and the hot and cold water flow control valve at the upper part of the main body with the control handle connected to it. The lower part of the hot and cold flow control valve is connected to the electronic valve that automatically opens and closes the outlet according to the detection signals of the object detector. The battery is connected to the object detector and electronic valve and the manual emergency lever is at the lower part of the main body that forcefully operates the electronic valve in an emergency.

### BRIEF DESCRIPTION OF THE SEVERAL VIEWS OR THE DRAWINGS

FIGS. 1 and 2 are perspective views of the present invention.

FIG. 3 is an exploded perspective view of the present invention.

FIGS. 4a and 4b are exemplary views of the upper main body structure in accordance with the present invention.

FIGS. 5a and 5b are exemplary views of the middle main body structure in accordance with the present invention.

FIGS. 6a and 6b are exemplary views of the lower main body structure in accordance with the present invention.

FIG. 7 is an exemplary view of the handle and hot and cold water flow control valve in accordance with the present invention.

FIG. 8 is an exemplary view of the electronic valve and manual emergency lever in accordance with the present invention.

FIGS. 9a and 9b are cross-section views of normal (closed) state of the valve in accordance with the present invention.

FIGS. 10a and 10b are cross-section views of in-service state of the valve in accordance with the present invention.

FIGS. 11a and 11b are cross-section views of the operation of the manual emergency lever in accordance with the present invention.

### DETAILED DESCRIPTION OF THE INVENTION

The mechanical composition of this invention can be described in detail as follows according to the attached drawings.

As shown in Drawing 1 and 11b, the automatic faucet comprises; the outlet (101); the main body with the hot and cold water inlets (102)(103); the hot and cold flow control valve built in the upper part of the main body for selection of hot and cold water and controlling the amount of the water flow (200); the control handle (300) for controlling the hot and cold flow control valve (200); the object detector (400) with the light generator (410) and receiver (420), operation indicator lamp (LED) (430) and circuit board (440) on the front of the main body (100); the electronic valve (500) which is connected to the lower part of the hot and cold flow control valve (200) and automatically opens and closes the outlet (101) according to the signals from the object detector (400); the battery supplying power to the object detector (400) and electronic valve (500); the manual emergency lever (700) that is at the lower part of the main body to forcefully operate the electronic valve in an emergency.

Here, the main body (100), as shown in Drawings 1 and 2, comprises the main body of this invention with the water outlet (101) on the front of the main body (100) and the cold water inlet (102) and hot water inlet (103) on both sides of the lower part of the main body (100). As shown in Drawing 9a, the hot and cold flow control valve (200), object detector (400), electronic valve (500) and manual emergency lever (700) are built in the main body (100).

The main body (100) comprises the upper part (110), middle part (120) and lower part (130) with the case (140) the cover them and the cold water inlet (102) and hot water inlet (103) on both sides of the lower part (130) and the cold water flow path (121)(111) and hot water flow path (122)(112) closely connecting the cold water inlet (102) and hot water inlet (103) of the hot and cold flow control valve (200) on either side of the middle part (120) and upper part (110). There is an exhalant siphon (113) closely connected to the outlet (230) of the hot and cold water flow control valve (200) at the center of the upper part (110). The upper part (110) is fastened by the lock nut (150), the upper part of which is fastened by the lock nut cover (151).

The cold water inlet (102) which the lower part (130) is equipped with, the cold water flow path (121) of the middle part (120), the cold water flow path (111) of the upper part (110), and the cold water inlet (210) of the hot and cold water flow control valve (200) are closely connected. And the hot water inlet (103) of the lower part (130), the hot water flow path (122) of the middle part (120), the hot water flow path (112) of the upper part (110), and the water inlet (220) of the hot and cold water flow control valve (200) are also closely connected.

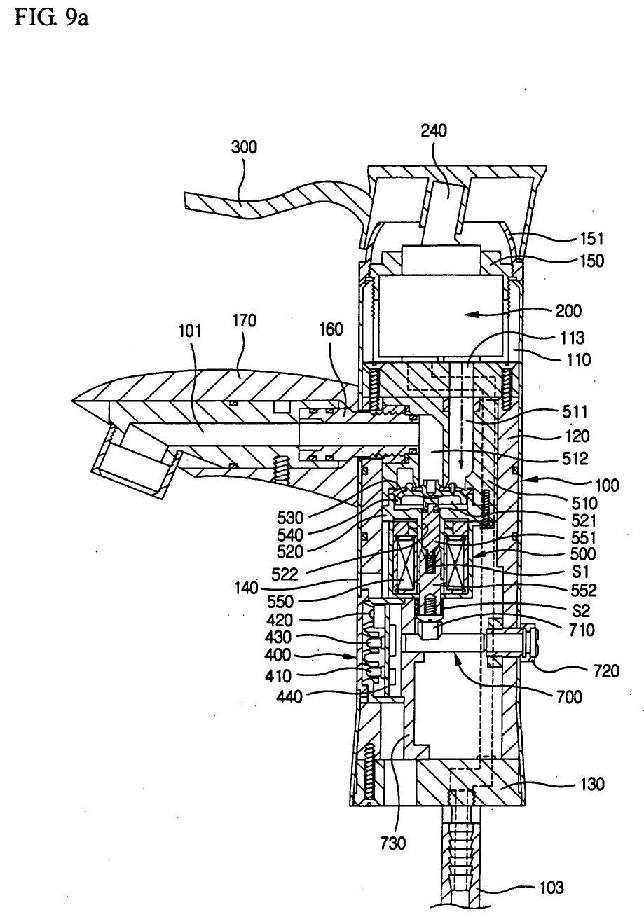

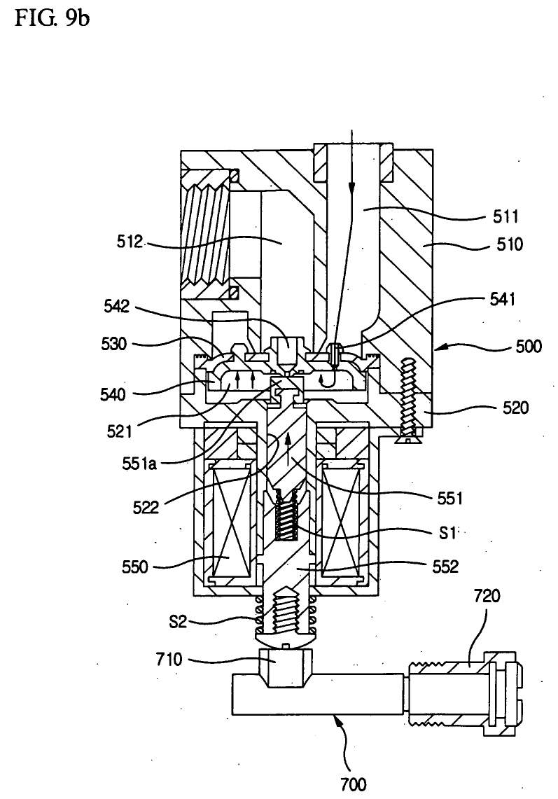

As in FIG. 9a, the inlet of the flow outlet (101) is connected by the joint (160) that goes through the middle part (120) and there is a cover (170) outside the flow outlet (101). At the rear of the joint (160) is the outlet (512) of the electronic valve (500), which is described below, connected by the nut.

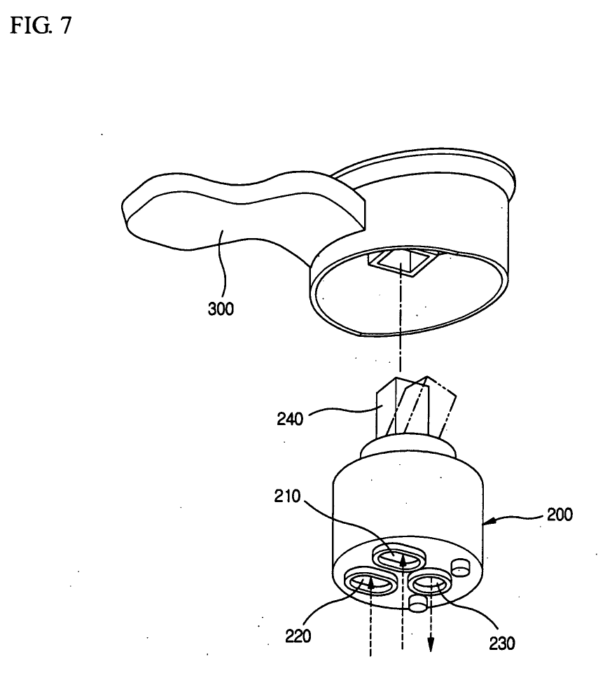

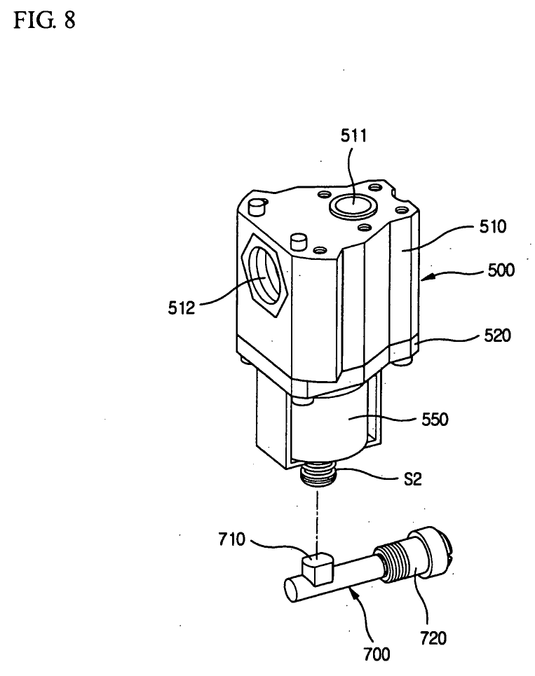

The hot and cold water flow control valve (200), which is built in the upper part of the main body (100), is for controlling the amount of the water flow and choosing between hot and cold water with the hot and cold water inlets (210)(220) that are connected to the hot and cold water flow path (111)(112) of the upper part (110) on both sides of the hot and cold water flow control valve (200) as shown in FIG. 7. At the central lower part of the hot and cold water flow control valve (200) is the outlet (230) connected to the exhalant siphon (113) of the upper part (110) and at the upper part of the hot and cold water flow control valve (200) is the control knob (240) connected to the control handle (300). The control knob (210) protrudes on the main body (100) to be connected to the control handle (300). If the user turns the control knob (240) clockwise, cold water flows in and if anti-clockwise, hot water flows into the hot water inlet (220). If the user pushes the control knob (240) backward, the amount of the water flow is adjusted and if the user pulls the control knob (240) forward fully, the hot and cold water inlets (210)(220) are closed with the water that has flowed into the hot and cold water inlets (210)(220) is discharged through the outlet (230).

The control handle (300) is designed to be protrude on the upper part of the main body (100) and is for controlling the hot and cold water flow control valve (200). The control handle (300) is connected to the control knob (240) of the hot and cold water flow control valve (200). That is how the user can conveniently choose between cold and hot water by turning the control handle (300) and properly control the amount of the cold or hot water by pushing or pulling upward and downward the control handle (300).

The object detector (400), which is installed on the front of the main body (100), has the light generator and receiver (410)(420), operation indicator lamp (430), and circuit board (440) as shown in FIG. 9a. If the object detector (400) detects the hand or an object, water is automatically discharged and otherwise, water is stopped. The circuit can also be configured so that the water continues to be discharged if an object is detected once and it stopped if detected once again.

The electronic valve (500), connected to the lower part of the hot and cold water flow control valve (200), automatically opens and closes the flow outlet (101) according to the signals of the object detector (400). The electronic valve (500) comprises the upper body (510) with the inlet (511) and outlet (512) connected to the exhalant siphon (113) at the upper part (110) and the flow outlet (101) respectively, the lower main body (520) connected by the screw at the lower part of the upper body (510) with the valve room (521) and operating hole (522), the packing (530) opening and closing the inlet (511) and outlet (512) in the valve room (521), the packing guide (540) connected to the lower part of the packing (530) with the inhalant siphon (541) connected to the inlet (511) and the exhalant siphon (542) connected to the outlet (512), and the latch solenoid (550) that opens and closes the exhalant siphon (542) with the upper and lower plungers (551)(552) fit into the operating hole (522) to receive the elasticity of the spring (S1)(S2).

The upper body (510) comprises the upper main body of the electronic valve (500). At one side of the upper body (510) is the inlet (511) connected to the exhalant siphon (113) of the upper part (110) and at the center of the upper body (510) is the outlet (512) connected to the flow outlet (101) of the main body (100). The inlet (511) and outlet (512) are designed to be connected to each other with the outlet (512) of the upper body (510) closely connected to the flow outlet (101) of the main body (100) by the joint (160).

The lower main body (520), which comprises the lower main body of the electronic valve (500), has the valve room (521) at the central upper part and the operating hole (522) at the central lower part. The valve room (521) of the upper body (510) is connected to the operating hole (522).

The packing (530), which is made from an elastic rubber material and is installed in the valve room (521) of the lower main body (520), is for opening and closing the inlet (511) and outlet (512).

The packing guide (540), which is connected to the lower part of the packing (520), has the inhalant siphon (541) connected to the inlet (511) of the upper body (510) at one side and the exhalant siphon (542) connected to the outlet (512) of the upper body (510).

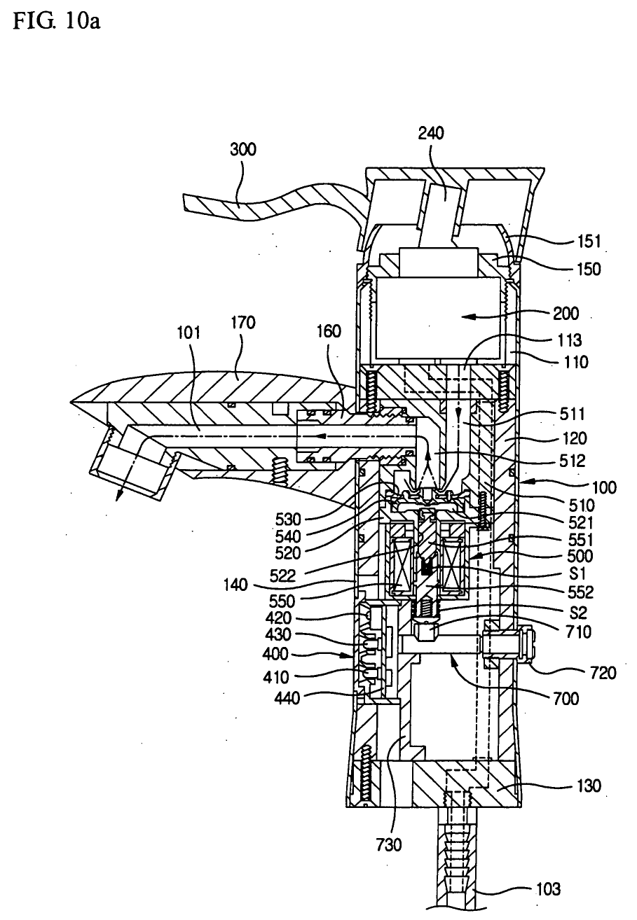

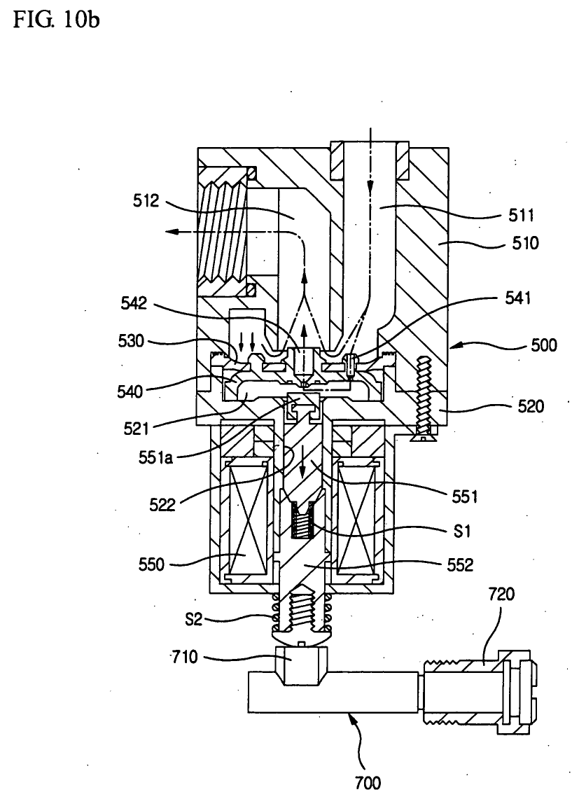

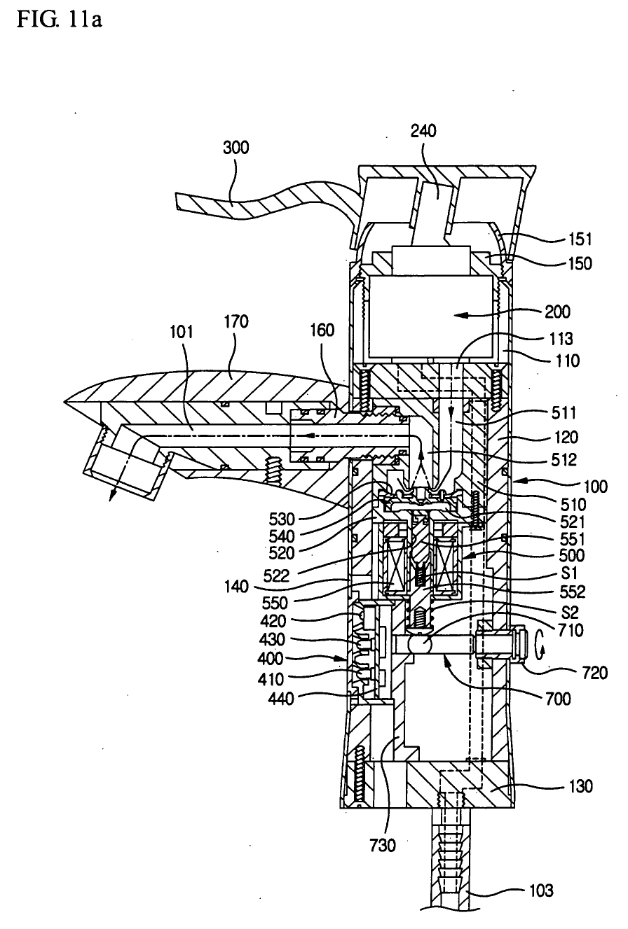

The latch solenoid (550) is for opening and closing the exhalant siphon (542) of the packing guide (540) and has the upper and lower plungers (551)(552) fit into the operating hole (522) to receive the elasticity of the spring (S1)(S2). The upper plunger (551) of the latch solenoid (550) automatically operates according to the signals of the object detector (400). It stays up at normal times (when there is no water flow) as shown in FIGS. 9a and 9b and when there is a water flow, as in FIGS. 10a and 10b, it is moved downward by the latch solenoid (550). At the upper part of the upper plunger (551) is the rubber packing (551a).

The battery (600) is for supplying power to the object detector (400) and electronic valve (500). The battery (600), the circuit board (430) of the object detector (400), and the latch solenoid (550) of the electronic valve (500) are electrically connected to each other.

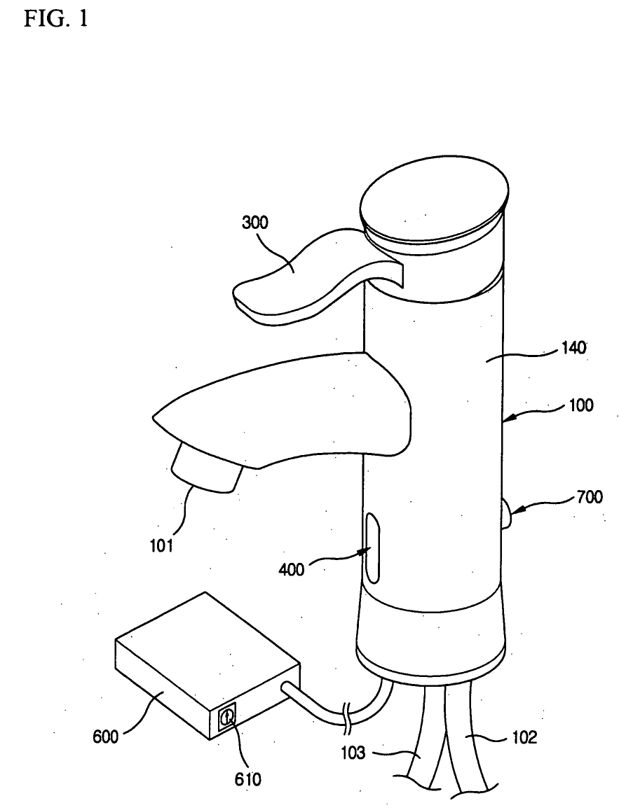

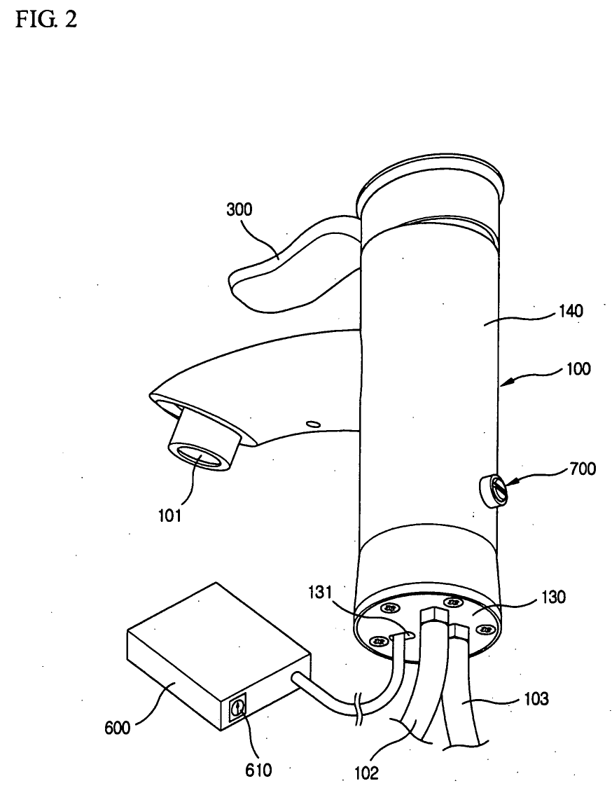

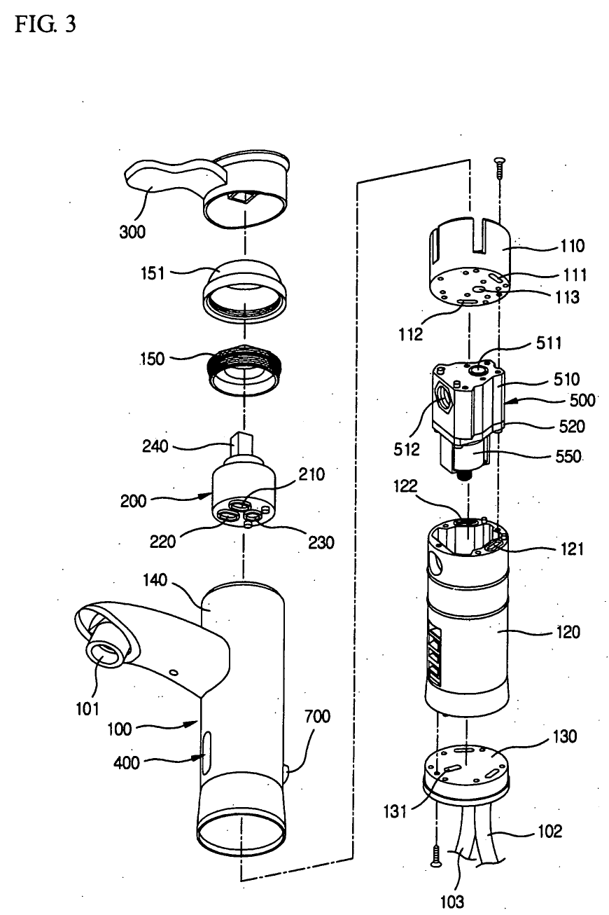

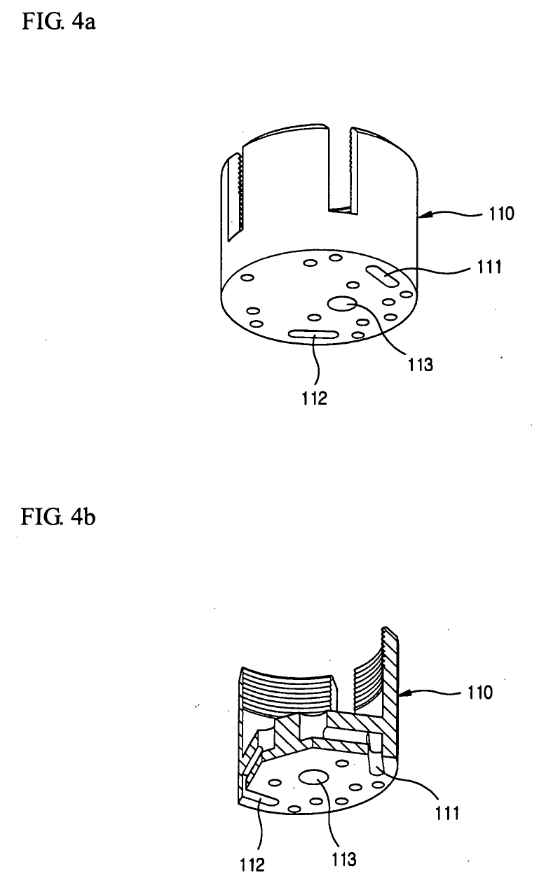

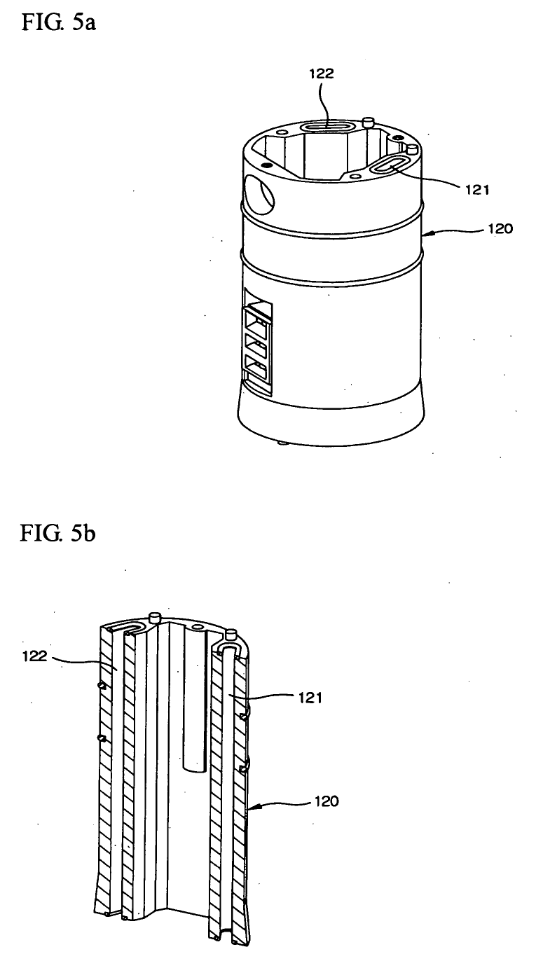

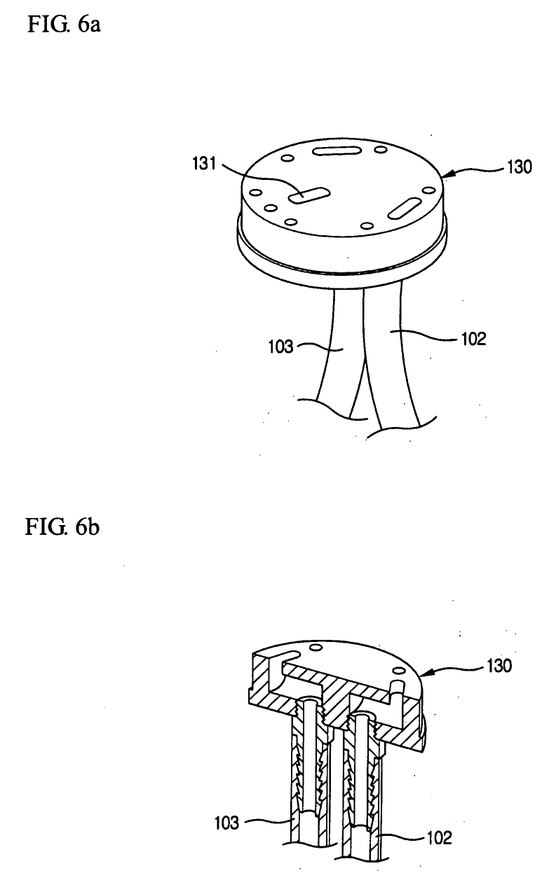

As in FIG. 1 and FIG. 2, the battery (600) is installed outside the main body (100) and has the detection distance sensitivity controlling volume (610). For this to happen, there is a wire inlet (131) at the lower part (130).

The manual emergency lever (700) is installed at the lower part of the main body (100) and can forcefully operate the electronic valve (500) in an emergency. It has the protruded support (710), which selectively supports the lower plunger (552). At the rear of it is the support ring (720) fixed onto the main body (100) and at the lower front of the manual emergency lever (700) is the support (730) fixed on the main body (100). The rear end of the manual emergency lever (700) protrudes on the main body (100) passing through the support ring (720) and at the protrusion is the driver hole where the driver is to be fit so that the lever can be easily turned with the driver in an emergency.

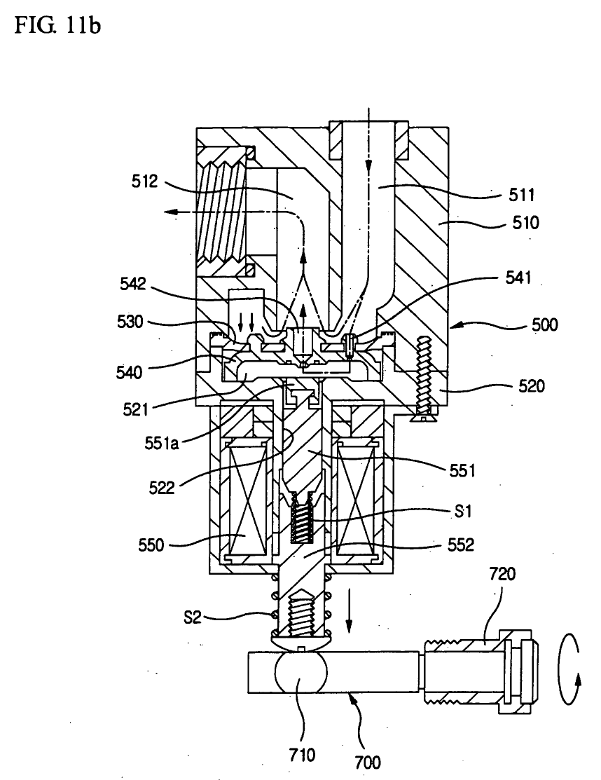

Therefore, as the protruded support (710) of the manual emergency lever (70) supports the lower plunger (552) at normal times as shown in FIGS. 9a, 9b, 10a and 10b, the latch solenoid (550) normally performs its originally intended function according to the signals of the object detector (400). However, if the manual emergency lever (700) is manually turned in an emergency as in FIGS. 11a and 11b, the inlet (511) and outlet (512) of the electronic valve (500) are forcefully opened because the lower plunger (552) and upper plunger (551) are dropped by the restitution force of the spring (S2).

The overall workings of this invention are described as follows according to the attached drawings.

First of all, hot or cold water is chosen by adjusting the hot and cold water flow control valve (200) with the control handle (300) and the amount of the water flow is properly set with the control handle (300) when installing the automatic faucet. Then the protruded support (710) of the manual emergency lever (700) should be placed at the central upper part so that is supports the lower plunger (552) of the latch solenoid (550) as shown in FIGS. 9a, 9b, 10a and 10b.

When no object is detected by the object detector (400), as in FIGS. 9a and 9b, the upper plunger (551) is moved upward by the latch solenoid (550) of the electronic valve (500). In this state, as the expansion force of the spring (S1) pushes it upward, the rubber packing (551a) of the upper plunger (551) closes the exhalant siphon (542) of the packing guide (540).

In the state shown in FIGS. 9a and 9b, water flows into the valve room (521) through the inhalant siphon (541) of the packing guide (540) with water pressure on the valve room (521) creating a vacuum in it. And as the water that has flowed in the valve room (521) gives pressure all over the bottom of the packing guide (540), the packing (530) is pushed against the inlet (511) and outlet (512) of the upper body (510) closing the inlet (511) and outlet (512) and automatically stopping the flow.

Next, if the user brings his or her hand under the flow outlet (101) to use the water, for example, the object detector (400) detects it and when the signal is detected by the object detector (400), the latch solenoid (550) of the electronic valve (500) is automatically activated.

When the latch solenoid (550) starts operating, as in FIGS. 10a and 10b, the upper plunger (551) moves downward pushing the spring (S1) and in this state, as the exhalant siphon (542) of the packing guide (540) is opened, the water pressure on the valve room (521) is discharged out of the outlet (512) of the upper body (510) through the exhalant siphon (542) of the packing guide (540).

In the state such as FIGS. 10a and 10b, the packing (530) and packing guide (540) are moved downward rapidly by the water pressure flowing in through the inlet (511), which moves the packing (530) apart from the inlet (511) and outlet (512) with the inlet (511) and outlet (512) of the electronic valve (500) opened. Finally, the water that has flowed through the inlet (511) is automatically discharged outside through the outlet (512) and the flow outlet (101) of the main body (100) for the user to be able to use the water. The path along which the water is discharged is the hot and cold water inlet (102)(103)→hot and cold water flow path (121)(122)→hot and cold water flow path (111)(112)→hot and cold water inlets (210)(220)→outlet (230)→exhalant siphon (113)→inlet (511)→outlet (512)→joint (160)→flow outlet (101) and then the water is finally discharged.

If an object is detected by the object detector (400), water is automatically discharged and if no object is detected, the water is automatically stopped. The circuit can also be configured so that the water continues to be discharged if an object is detected once and it stopped if detected once again.

In addition, the user can choose between hot and cold water by manually manipulating the control handle (300) and can also adjust the amount of the water flow by manually manipulating the control handle (300).

Meanwhile, if the object detector (400) and electronic valve (500) stop working due to the discharge of the battery (600) and therefore the automatic faucet cannot automatically operate, that is, in an emergency, if the user manually turns the manual emergency lever (700) as shown in FIGS. 11a and 11b, the protruded support (710), which supports the lower plunger (552) of the latch solenoid (550), falls apart from the lower plunger (552) rotating. And as the lower plunger (552) and the upper plunger (551) simultaneously fall because of the restitution force of the spring (S2), the inlet (551) and outlet (512) are forcefully opened so that the water is discharged through the flow outlet (101). Therefore, in an emergency when the automatic faucet cannot automatically work, it turns into the manual mode in which the water can be used by turning the manual emergency lever (700) manually and manipulating the hot and cold water flow control valve (200).

Water can be used uninterruptedly in an emergency, too because it is possible to stop the water by turning the manual emergency lever (700) to its original position as in FIGS. 9a, 9b, 10a, and 10b after using the water by making it forcefully discharged with manual manipulation of the manual emergency lever (700), or by using the control handle (300) without using the manual emergency lever (700).

Therefore, as this invention can automatically discharge water by detecting the object under the object detector (400) at normal times and the user can also manually get the water discharged by manipulating the manual emergency lever (700), it has the merit of being more easily used by the user either automatically or manually.

The user can also easily choose between hot and cold water by manipulating the control handle (300) and can properly adjust the amount of the water flow by using the control handle (300). This invention enables the user to easily use both hot and cold water by manipulating the manual emergency lever (700) when the object detector (400) and the electronic valve (500) stop working due to the battery (600) discharge or in an emergency.

As described above, the automatic faucet with the hot and cold water flow control valve built in it makes both manual and automatic use easier. In addition, the user can adjust the amount of the water flow and can also use both hot and cold water when the object detector (400) and the electronic valve (500) stop working due to the battery (600) discharge or in an emergency.

What is claimed is:

1. An automatic faucet comprising the flow outlet (101); the main body with the hot and cold water inlets (102)(103); the hot and cold flow control valve built in the upper part of the main body for selection of hot and cold water and controlling the amount of the water flow (200); the control handle (300) for controlling the hot and cold flow control valve (200); the object detector (400) with the light generator (410) and receiver (420), operation indicator lamp (LED)(430) and circuit board (440) on the front of the main body (100); the electronic valve (500) which is connected to the lower part of the hot and cold flow control valve (200) and automatically opens and closes the outlet (101) according to the signals from the object detector (400); the battery supplying power to the object detector (400) and electronic valve (500); the manual emergency lever (700) that is at the lower part of the main body to forcefully operate the electronic valve in an emergency.

2. An automatic faucet in accordance with claim 1, wherein said automatic faucet has the hot and cold water flow control valve, which has the following structural features: the main body (100) comprises the upper part (110), middle part (120), and lower part (130) with the case (140) outside, with the hot and cold water inlet (102)(103) on both sides of the lower part (130), with the cold water flow path (121)(111) and hot water flow path (122)(112) that connect the hot and cold water inlet (102)(103) and the hot and cold water inlets (210)(220) of the hot and cold water flow control valve (200) on both sides of the middle part (120) and upper part (110), and with the exhalant siphon (113) connected to the outlet (230) of the hot and cold water flow control valve (200) at the center of the upper part (110).

3. An automatic faucet in accordance with claim 1, wherein said automatic faucet has the hot and cold water flow control valve, which has the following structural features: the electronic valve (500) comprises; the upper body (510) that has the inlet (511) and outlet (512) respectively connected to the exhalant siphon (113) and the flow outlet (101) of the main body (100); the lower main body (520) that is connected to the lower part of the upper body (510) and that has the valve room (521) and operating hole (522); the packing (530) that is installed in the valve room (521) and that opens and closes the inlet (511) and the outlet (512); the packing guide (540) that is connected to the lower part of the packing (530) and that has the inhalant siphon (541) connected to the inlet (511) and the exhalant siphon (542) connected to the outlet (512); and the latch solenoid (550) that has the upper and lower plungers (551)(552) fit into the operating hole (522) to receive the elasticity of the spring (S1)(S2) and that opens and closes the exhalant siphon (542).
In addition, the automatic faucet has the hot and cold water flow control valve with the protruded support (711) which electively supports the lower plunger (552) in the manual emergency lever (700).

4. An automatic faucet in accordance with claim 1, wherein said battery (600) is to be put on the exterior of the main body (100) with the volume for adjusting the detection distance sensitivity.
